(19) United States
(12) Patent Application Publication
(10) Pub. No.: US 2014/0354868 A1
(43) Pub. Date: Dec. 4, 2014

(54) PORTABLE HYPERSPECTRAL IMAGER

(71) Applicant: Corning Incorporated, Corning, NY (US)

(72) Inventors: Leon J. Desmarais, Claremont, NH (US); Richard Lynton Wiggins, Keene, NH (US); Patrick W. Woodman, Marlborough, NH (US)

(73) Assignee: Corning Incorporated, Corning, NY (US)

(21) Appl. No.: 14/258,204

(22) Filed: Apr. 22, 2014

Related U.S. Application Data
(60) Provisional application No. 61/830,890, filed on Jun. 4, 2013.

(51) Int. Cl. H04N 5/232

(52) U.S. Cl. CPC H04N 5/23293
USPC 348/333.01

(57) ABSTRACT

A portable hyperspectral imager. The imager is modular and may include a hyperspectral camera and a removably-coupled mobile display module. The hyperspectral camera may include an Offner spectrometer. The mobile display module may be adapted to receive data from the hyperspectral camera and may include an internal camera. The mobile display module may include a cell phone or a tablet computer. The mobile display module may be integrally attached to the hyperspectral camera. The integral attachment may include a data link or USB connection. The length of the data link or USB connection may be less than 6 inches and the imager may weigh less than one pound. The imager may include a battery module or a scanning optical module.

This application claims the benefit of priority under 35 U.S.C. §119 of U.S. Provisional Application Ser. No. 61/830,890 filed on Jun. 4, 2013, the content of which is relied upon and incorporated herein by reference in its entirety.

### FIELD OF THE DISCLOSURE

This disclosure relates to hyperspectral imaging. More particular, this disclosure relates to a portable hyperspectral imager. More particularly, this disclosure relates to a portable hyperspectral imager that includes a hyperspectral camera interfaced with a mobile display device.

### BACKGROUND OF THE DISCLOSURE

Hyperspectral imaging is emerging as the leading technique for remote imaging and detection. Applications of hyperspectral imagining include airborne reconnaissance in military and aerospace applications, environmental monitoring, agricultural monitoring, geological surveying, mineral exploration, and medical diagnosis.

Hyperspectral imaging systems measure the spectral features of objects in real-world scenes. Typically, the scene is broken into a grid and a spectrum is measured for each element of the grid. The spectrum typically consists of light reflected and/or scattered from objects in the scene. During imaging, the scene of interest is divided into slices and each slice is imaged separately. The image of the scene is acquired by sequentially sampling the slices.

Hyperspectral image acquisition involves acquiring spectra for each slice of the scene over a wide range of wavelengths. The wide wavelength range is desirable because different objects in a scene reflect or scatter light at multiple wavelengths and by acquiring spectral data over a wide wavelength range, it becomes possible to identify and discriminate between different objects in a scene with greater precision. To improve the quality of the hyperspectral image, it is necessary to insure high spatial resolution and high wavelength resolution. High wavelength resolution is achieved in hyperspectral imaging by dividing the detected wavelength range into a series of narrow contiguous wavelength bands and detecting each band separately. The wavelength bands in hyperspectral imaging may be 10 nm or less. Acquiring spectra over the series of narrow wavelength bands provides more detail about the objects in the scene and allows for accurate fingerprinting of individual objects. The ability to narrow the wavelength range of detected spectral bands has been made possible by recent advances in detector design, image processing and data storage.

A typical hyperspectral imaging system includes a scanning mirror, an imaging lens, and a spectrometer with an entrance slit and a focal plane array detector. The scanning mirror and lens image a slice of a real-world scene on the spectrometer's entrance slit. The focal plane array detector measures the spectra for multiple scene elements along the slice of the scene that falls on the entrance slit. The scanning mirror scans the scene across the entrance slit, allowing for spectral measurement of the scene as multiple slices.

Current hyperspectral imaging systems are bulky and heavy. It is also difficult during scanning to determine which slice of the scene is being sampled. This is because the wavelength range acquired by the hyperspectral imaging system is much wider than the wavelength range detected by the human eye. As a result, the appearance of a hyperspectral image is much different than the image perceived by a human observer and it is difficult to correlate features in a hyperspectral image with physical objects as ordinarily visualized by humans.

There remains a need for a hyperspectral imaging system that is lightweight and portable. The also remains a need for a hyperspectral imaging system that allows the user to readily visualize the portion of a real-world scene being examined by the hyperspectral imager in real time.

### SUMMARY

The present disclosure provides a portable hyperspectral imaging system. The imaging system may include a hyperspectral camera and a mobile display device.

The hyperspectral camera may include a wavelength-dispersing element and a detection element. The wavelength-dispersing element receives light from a scene and separates it into a plurality of different wavelengths. The wavelength-dispersing element may be a spectrometer, or an Offner spectrometer. The wavelength-dispersing element may direct the plurality of wavelengths to the detection element. The detection element may detect the intensity, wavelength, polarization or other characteristics of the plurality of wavelengths. The hyperspectral camera may include a data processor.

The mobile display device may be removably coupled to the hyperspectral camera and may be adapted to receive data from the hyperspectral camera. The data received by the mobile display device may be produced by the detection element or the data processor of the hyperspectral camera. The data received by the mobile display device may be image data. The image data may be spectral data, or wavelength data, or polarization data, or intensity data. The mobile display device may include a data processor and software to display, analyze, or process image data.

The mobile display device may be a cell phone, or a tablet computer, or an application specific or customized display device to meet specific functional requirements. The mobile display device may be removably coupled to the hyperspectral camera via a data link. The data link may be a USB connection. The length of the data link or USB connection cable may be less than 12 inches, or less than 6 inches or less than 3 inches or less than 1 inch. When coupled to the hyperspectral camera, the mobile display device may be integrally attached thereto.

The mobile display device may include a camera. The direction of focus of the camera of the mobile display device may coincide with the direction of image acquisition of the hyperspectral camera. The camera of the mobile display device may detect the scene acquired by the hyperspectral camera. The mobile display device may include a wireless adapter.

The hyperspectral imaging system may include a battery module. The battery module may removably couple to the hyperspectral camera. The battery module may include a rechargeable battery.

The hyperspectral imaging system may include a scanning optical module. The scanning optical module may include moveable optics configured to scan a scene and to direct image slices acquired from the scene to the hyperspectral camera. Rotation or other repositioning of the moveable optics permits a scan or sweep of the entire scene. The scanning optical module may include a moveable mirror.

The hyperspectral imaging system may be a handheld unit. The hyperspectral imaging system may weigh less than 5 lbs., or less than 3 lbs., or less than 1 lb.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present disclosure, and together with the description serve to explain principles and operation of methods, products, and compositions embraced by the present disclosure.

### BRIEF DESCRIPTION OF THE DRAWINGS

FIG. 1 depicts a hyperspectral camera.

FIG. 2 depicts a modular hyperspectral imaging system.

FIG. 3 depicts front and rear views of an assembled modular hyperspectral imaging system.

FIG. 4 depicts front and rear views of a modular hyperspectral imaging system adapted for hand scanning mode.

### DETAILED DESCRIPTION

The present disclosure provides a hyperspectral imaging system that features portability and an ability to visually track the scene in real time during scanning. The hyperspectral imaging system may be modular and may include one or more of a hyperspectral camera, a mobile display device, a battery module, and a scanning optical module.

The hyperspectral camera may include a wavelength-dispersing element and a detection element. The wavelength-dispersing element receives light and separates or disperses light according to wavelength. The wavelength-dispersing element may include optics such as prisms, lenses, and mirrors. The wavelength-dispersing element may be a spectrometer. The spectrometer may be an Offner spectrometer. An Offner spectrometer is a particularly compact spectrometer that enables miniaturization of the present hyperspectral imaging system. An example of an Offner spectrometer is described in U.S. Pat. No. 7,697,137, the disclosure of which is hereby incorporated in its entirety herein. The wavelength-dispersing element may direct light to the detection element. The detection element may detect the wavelength, intensity, polarization or other characteristic of the light dispersed by the wavelength-dispersing element. The detection element may be a photodetector, a CCD device, a diode array, a focal plane array, a CMOS device, or other type of image detector known in the art for sensing electromagnetic radiation reflected over the wavelength range associated with physical objects in real-world scenes.

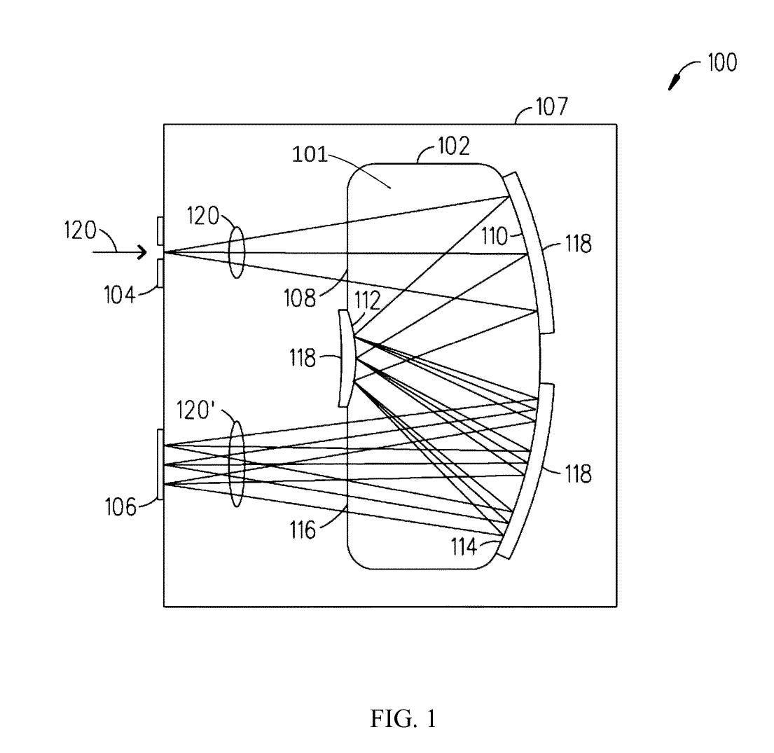

FIG. 1 illustrates a hyperspectral camera that includes a monolithic Offner spectrometer and a detector. Hyperspectral camera 100 incorporates a monolithic Offner spectrometer 102 within optical housing 107. Hyperspectral camera 100 includes a slit 104 and a detector 106 attached to optical housing 107. In the configuration shown, the monolithic Offner spectrometer 102 is a one-one optical relay made from a single piece of transmissive material 101 including an entrance surface 108, a first mirror 110 (formed when a reflective coating 118 is applied as shown to the surface of transmissive material 101), a diffraction grating 112 (formed when a reflective coating 118 is applied as shown to the surface of transmissive material 101), a second mirror 114 (formed when a reflective coating 118 is applied as shown to the surface of transmissive material 101) and an exit surface 116.

The hyperspectral camera 100 operates to produce images of a remote object (not shown) over a contiguous range of narrow spectral bands when the slit 104 receives a beam 120 from the remote object and directs the beam 120 to the monolithic Offner spectrometer 102. Monolithic Offner spectrometer 102 diffracts the beam 120 and forwards the diffracted beam 120′ to the detector 106. In particular, the slit 104 directs the beam 120 to the entrance surface 108. First mirror 110 receives the beam 120 transmitted through the entrance surface 108 and reflects the beam 120 towards the diffraction grating 112. The diffraction grating 122 receives the beam 120 and diffracts and reflects the diffracted beam 120′ to the second mirror 114. The second mirror 114 receives the diffracted beam 120′ and reflects the diffracted beam 120′ to the exit surface 116. The detector 106 processes the diffracted beam 120′ received from exit surface 116.

Transmissive material 101 is selected to have high transparency over the range of wavelengths acquired from the scene during imaging. Wavelengths of interest may include near infrared wavelengths, visible wavelengths, and/or ultraviolet wavelengths. Materials suitable for transmissive material 101 include plastics, dielectrics, and gases (e.g. air, nitrogen, argon etc.). When gases are employed, mirror 110, mirror 114, and grating 118 are affixed to optical housing 107 through posts or other mounts.

Detector 106 is selected to have a wavelength (color) sensitivity based on the type of transmissive material 101 used to make the monolithic Offner spectrometer 102. For instance, if the monolithic Offner spectrometer 102 were made from a plastic (e.g., polymethylmethacrylate (PMMA), polystyrene, polycarbonate) then the diffracted wavelength range would be primarily in the visible and the detector 106 could be a complementary metal-oxide-semiconductor (CMOS) video camera 106. If the monolithic Offner spectrometer 102 were made from an infrared transmitting material, then the detector 106 would be an IR detector, such as one based on mercury cadmium telluride (HgCdTe), indium antimonite (InSb) or lead sulphide (PbS).

Hyperspectral camera 100 may further include additional optics to receive or direct beam 120 and/or diffracted beam 120′ to or from different directions to permit flexible positioning of slit 104 and/or detector 106 with respect to optical housing 107.

The hyperspectral camera may include a data processor to process image data acquired from the scene. The image data may include spectral data, wavelength data, polarization data, intensity data, or positional data. The data processor may receive image data from the detection element and transform or otherwise manipulate image data into a form specified by the user. Data processing may include conversion of image data to any of several visual forms known in the art and may include coloring, shading, or other visual effects intended to represent position, depth, composition, or other features of objects in the scene. Data received and/or processed by the hyperspectral camera may be transferred to the mobile display device for further processing and/or display. The data transfer may occur through a data interface, such as a data link or USB connection. The hyperspectral camera may also include memory. The memory may be used to store image data. The image data may be unprocessed or processed image data. Image data stored in the hyperspectral camera may be downloaded to an external computer for processing. Image data stored in the hyperspectral camera may be processed offline.

The mobile display module includes a mobile display device. The mobile display device is a portable, handheld device that includes a display screen and an interface adapted to receiving data from the hyperspectral camera. The interface may permit establishment of a data link between the mobile display device and hyperspectral camera. The data interface may be a USB interface and the data link between the mobile display device and hyperspectral camera may be a USB connection. The length of the data link may be less than 12 inches, or less than 8 inches, or less than 4 inches, or less than 2 inches, or less than 1 inch. The mobile display device may be a cellphone, or a tablet computer.

The mobile display device may be integrally attached to the hyperspectral camera. The integral attachment may include a data link. The mobile display device may be removably coupled to the hyperspectral camera. The removable coupling permits detachment of the mobile display device from the hyperspectral camera. When detached, the mobile display device may maintain a data connection with the hyperspectral camera. The data connection may be a wired data connection or wireless data connection. The mobile display device may include a wireless adapter and may exchange data in wireless mode with the hyperspectral camera, an external computer, or an external network.

The mobile display device may include a data processor and software for processing or displaying data received from the hyperspectral camera. The mobile display device may also include memory. The memory may be used to store image data received from the hyperspectral camera. The image data may be unprocessed or processed by the hyperspectral camera. Image data stored in the mobile display device may be downloaded to an external computer for processing. Image data stored in the mobile display device may be processed offline.

The mobile display device may include a camera. The camera permits image acquisition independent of the hyperspectral camera and constitutes a second camera within the hyperspectral imaging system. The camera may be oriented in the direction of image acquisition of the hyperspectral camera and may acquire image data from the scene or scene slice being surveyed by the hyperspectral camera. The camera of the mobile display device may provide an image of the spatial position within the scene being sampled by the hyperspectral camera and may aid in the alignment of the hyperspectral camera. The mobile display device may process image data received from the camera of the mobile display device and image data received from the hyperspectral camera to form a composite image. The composite image may include a comparison of image elements as perceived by a human observer and as analyzed or processed by the hyperspectral camera.

The mobile display device may include a touch screen. The mobile display device may control operation of the hyperspectral camera. For example, software, touch, or push button controls of the mobile display device may initiate or control image acquisition by the hyperspectral camera as well as processing, storage or transfer of image data acquired by the hyperspectral camera. Control of the hyperspectral camera may occur through the data link connecting the mobile display device to the hyperspectral camera.

The hyperspectral imaging system may include a battery module. The battery module may include a rechargeable battery and may be removably coupled to the hyperspectral camera, the mobile display device, or other module of the hyperspectral imaging system. Battery power may also be provided by a battery contained within the mobile display device. The hyperspectral imaging system may also be adapted to receive power from an external battery.

The hyperspectral imaging system may include a scanning optical module. The scanning optical module may include moveable optics for scanning a scene. The moveable optics may acquire image data from a slice of a scene and may be systematically repositioned or reconfigured to continuously sample a scene in a slice-by-slice fashion. Slice image data acquired by the scanning optical module may be directed to the hyperspectral camera for acquisition and processing. The scanning optical module may include rotatable optical elements, such as a rotatable mirror or lense. The scanning optical module may be removably coupled to the hyperspectral camera, the mobile display device, or rechargeable battery module.

The hyperspectral imaging system is compact and lightweight. The longest linear dimension of the hyperspectral imaging system may coincide with the longest linear dimension of the mobile display device. The longest linear dimension of the hyperspectral imaging system may be less than 16 inches, or less than 14 inches, or less than 12 inches, or less than 10 inches, or less than 8 inches, or less than 6 inches. The hyperspectral imaging system may weigh less than 5 lbs., or less than 3 lbs., or less than 1 lb. The hyperspectral imaging system may be a handheld system that permits image acquisition by hand scanning Image acquisition is also possible in scanning optical mode as described hereinabove and in pushbroom mode. The hyperspectral imaging system may include a mount for a pistol grip for handheld implementation. The hyperspectral imaging system may include a mount for placement on a tripod.

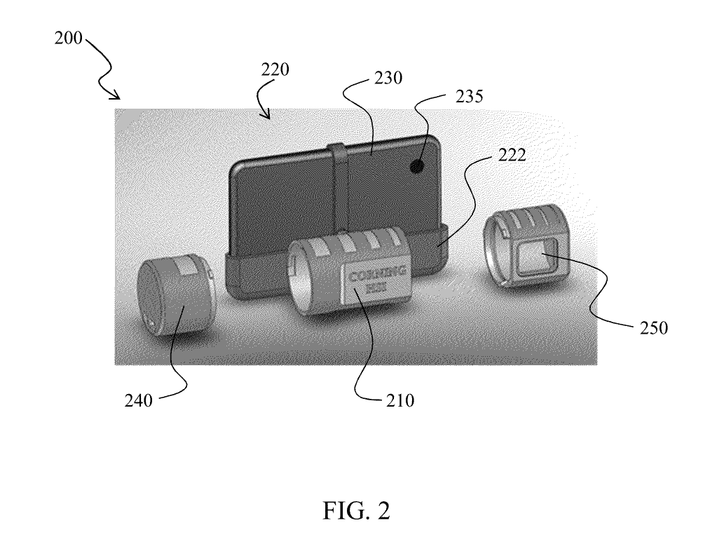

FIG. 2 shows a modular hyperspectral imaging system in accordance with the present disclosure. Imaging system 200 includes hyperspectral camera 210, mobile display module 220 that includes mount 222 and mobile display device 230 equipped with a camera having entrance aperture 235, battery module 240 and scanning optical module 250.

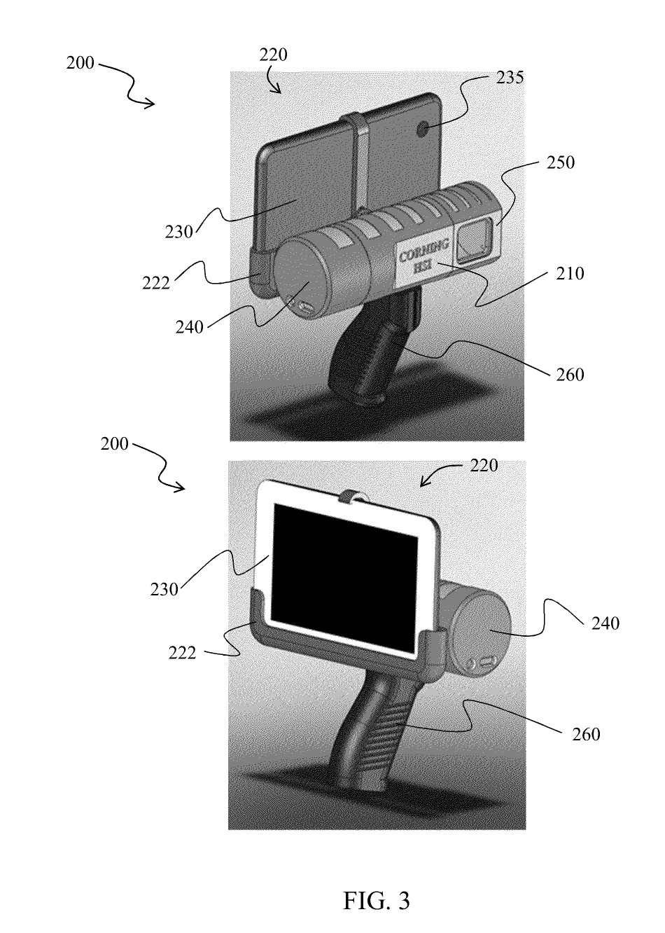

FIG. 3 shows modular hyperspectral imaging system 200 from FIG. 2 in assembled form in front and rear view. FIG. 3 further shows inclusion of grip 260 to facilitate use of hyperspectral imaging system 200 in hand scanning mode.

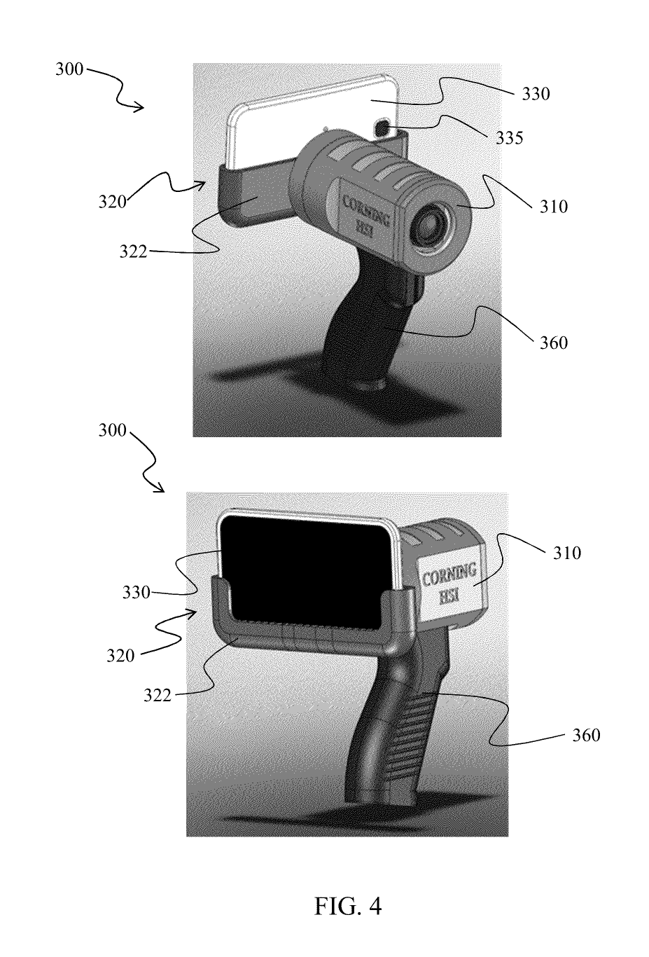

FIG. 4 shows modular hyperspectral imaging system 300 that includes hyperspectral camera 310, mobile display module 320 that includes mount 322 and mobile display device 330 equipped with a camera having entrance aperture 335, and grip 360. Hyperspectral imaging system 300 is conveniently used for hand scanning and may be powered by a battery contained with mobile display device 330.

The present disclosure further extends to methods of acquiring images. The methods including using the portable hyperspectral imaging system described herein to acquire an image. The image acquisition method may include selecting a scene and acquiring an image of the scene using a portable hyperspectral imaging system in accordance with the present disclosure.

The compact design and low weight of the present hyperspectral imaging system makes it suitable for hand scanning applications. The hyperspectral imaging system may be conveniently lifted and supported in one or both hands by the operator without a need for a tripod or other mounting system. The hyperspectral imaging system may be supported solely in the hand or hands of a user and may have no direct or indirect contact with the ground or other supporting medium. The method of the present disclosure may include providing a portable hyperspectral imaging system, supporting the hyperspectral imaging system in a hand of the operator, and acquiring an image while supporting the hyperspectral imaging system solely by hand. The image may be acquired through hand motion of the hyperspectral imaging system by the operator, or by ambulation of the operator.

Operation of the hyperspectral camera may be controlled by the mobile display device. The method may include using software, a touch command, or pushbutton controls of the mobile display device to initiate or control image acquisition, image processing, or storage of image data by the hyperspectral camera.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the present embodiments. Since modifications combinations, sub-combinations and variations of the disclosed embodiments incorporating the spirit and substance of the present description may occur to persons skilled in the art, the description should be construed to include everything within the scope of the appended claims and their equivalents.

What is claimed is:

1. A portable hyperspectral imaging system comprising:
a hyperspectral camera, said hyperspectral camera including a wavelength-dispersing element and a detection element; and
a mobile display device removably coupled to said hyperspectral camera.

2. The portable hyperspectral imaging system of claim 1, wherein said wavelength-dispersing element includes an Offner spectrometer.

3. The portable hyperspectral imaging system of claim 1, wherein said detection element is a photodetector, CCD, diode array, CMOS device, or focal plane array.

4. The portable hyperspectral imaging system of claim 1, wherein said hyperspectral camera further includes a data processor.

5. The portable hyperspectral imaging system of claim 1, wherein said mobile display device includes a cell phone.

6. The portable hyperspectral imaging system of claim 1, wherein said mobile display device includes a tablet computer.

7. The portable hyperspectral imaging system of claim 1, wherein said mobile display device includes a camera.

8. The portable hyperspectral imaging system of claim 7, wherein said camera of said mobile display module includes an entrance aperture, said entrance aperture being oriented in the direction of imaging of said hyperspectral camera.

9. The portable hyperspectral imaging system of claim 1, wherein said mobile display device includes a wireless adapter.

10. The portable hyperspectral imaging system of claim 1, further comprising a data link between said hyperspectral camera and said mobile display device.

11. The portable hyperspectral imaging system of claim 10, wherein said data link includes a USB connection.

12. The portable hyperspectral imaging system of claim 10, wherein the length of said data link is less than 6 inches.

13. The portable hyperspectral imaging system of claim 1, further comprising a battery module removably coupled to said hyperspectral camera of said mobile display device.

14. The portable hyperspectral imaging system of claim 1, further comprising a scanning optical module removably coupled to said hyperspectral camera.

15. The portable hyperspectral imaging system of claim 1, wherein said imaging system weighs less than three pounds.

16. A method of acquiring an image comprising:
selecting a scene; and
acquiring an image of said scene with the portable hyperspectral imaging system of claim 1.

17. A method of acquiring an image comprising:
providing a portable hyperspectral imaging system;
supporting said portable hyperspectral imaging system, said supporting occurring solely by hand; and
acquiring an image with said hand-supported portable hyperspectral imaging system.

18. The method of claim 17, wherein said acquiring image includes moving said hand-supported portable hyperspectral imaging system.

19. The method of claim 17, wherein said hyperspectral imaging system includes a hyperspectral camera and a mobile display device removably coupled to said hyperspectral camera.

20. The method of claim 19, wherein said acquiring image includes using said mobile computing device to initiate image acquisition by said hyperspectral camera.
